(19) United States
(12) Patent Application Publication
(10) Pub. No.: US 2022/0044674 A1
(43) Pub. Date: Feb. 10, 2022

(54) AI SPEECH RECOGNITION SYSTEM CAPABLE OF SELECTING MODELS

(71) Applicant: National Chiao Tung University, Hsinchu (TW)

(72) Inventors: Sin Horng CHEN, Hsinchu (TW); Yuan Fu LIAO, Hsinchu (TW); Yih Ru WANG, Hsinchu (TW); Shaw Hwa HWANG, Hsinchu (TW); Bing Chih YAO, Hsinchu (TW); Cheng Yu YEH, Hsinchu (TW); You Shuo CHEN, Hsinchu (TW); Yao Hsing CHUNG, Hsinchu (TW); Yen Chun HUANG, Hsinchu (TW); Chi Jung HUANG, Hsinchu (TW); Li Te SHEN, Hsinchu (TW); Ning Yun KU, Hsinchu (TW)

(21) Appl. No.: 16/988,745

(22) Filed: Aug. 10, 2020

(51) Int. Cl. G10L 15/183; G10L 15/30; G10L 15/16; G10L 15/22; G06N 3/04; G06N 3/08

(52) U.S. Cl. CPC G10L 15/183; G10L 15/30; G06N 3/08; G10L 15/22; G06N 3/04; G10L 15/16

(57) ABSTRACT

The present invention provides a system for selecting a special speech recognition model through a general model of an AI speech recognition system for users to select an appropriate model. In addition to the AI speech recognition server of a general model, the present invention additionally prepares speech models in various fields, such as sports event model, financial news model, and game live model. Different users can choose different speech models according to their needs or fields, and they can get better services respectively. If the different users have no special choice, the AI speech recognition server of the general model provides speech recognition services for the different users.

### FIELD OF THE INVENTION

The present invention relates to a system for selecting speech recognition models, and more particularly to a system for selecting a special speech recognition model through a general model of an AI speech recognition system.

### BACKGROUND OF THE INVENTION

A “Yating verbatim” on the Taiwan market uses a technique of Automatic Speech Recognition (ASR) for developing into a speech recognition system in real time. A recording file can be converted into a text file by “Yating verbatim”, punctuation marks are automatically added according to the speech content during recognition. It is suitable for interviews, meeting records, etc.

The “Yating verbatim” is suitable for interviews and meeting records, but is not useful in higher level of financial news report, sports event report, game live report, because relevant professional vocabularies are too few.

FIG. 1 describes an AI speech recognition service of a general model 1 on the market. Users 2, 3 and 4 cannot select models, since professional vocabularies used by users 2, 3, 4 are too abundant, the general model 1 (such as the “Yating verbatim”) cannot recognize accurately.

Today AI (Artificial Intelligence) is commonly used. It is very convenient for users to apply AI methods (such as artificial neural networks) to the current Automatic Speech Recognition (ASR) system for generating desired models for different fields, so users can select appropriate models to use.

### SUMMARY OF THE INVENTION

The object of the present invention is to provide a system for selecting a special speech recognition model through a general model of an AI speech recognition system for users to select an appropriate model. The system of the present invention is described below.

In addition to the AI speech recognition server of a general model, the present invention additionally prepares speech models in various fields, such as sports event model, financial news model, and game live model.

Different users can select different speech models according to their needs or fields, and they can get better services respectively.

If the different users have no special choice, the AI speech recognition server of the general model provides speech recognition services for the different users.

### BRIEF DESCRIPTION OF THE DRAWINGS

FIG. 1 shows schematically a diagram for describing a general model of an AI speech recognition system.

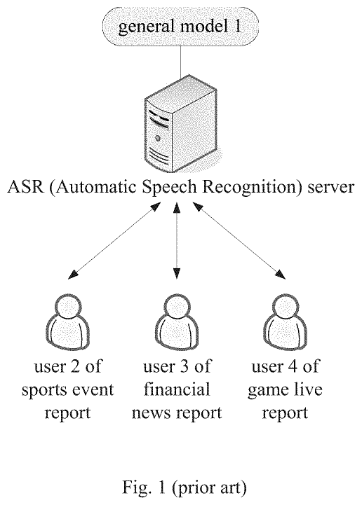

FIG. 2 show schematically the main structure according to the present invention.

FIG. 3 shows schematically a flow chart for generating various models of different parameters according to the present invention.

FIG. 4 shows schematically a parameter model of Automatic Speech Recognition (ASR) in relevant field is obtained according to the present invention.

FIG. 5 shows schematically that for different users to prepare various models of different parameters according to the present invention.

FIG. 6 shows schematically that different users select relevant parameter models according to the present invention.

### DETAILED DESCRIPTIONS OF THE PREFERRED EMBODIMENTS

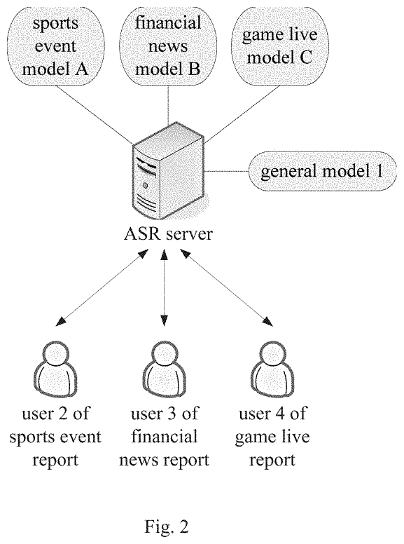

FIG. 2 shows schematically the main structure according to the present invention. In addition to the AI speech recognition server of a general model 1, the present invention additionally prepares speech models in various fields, such as sports event model A, financial news model B, and game live model C. Different users can choose different speech models according to their needs or fields. For example, the user 2 can select sports event model A, the user 3 can select financial news model B, the user 4 can select game live model C, and they can get better services respectively.

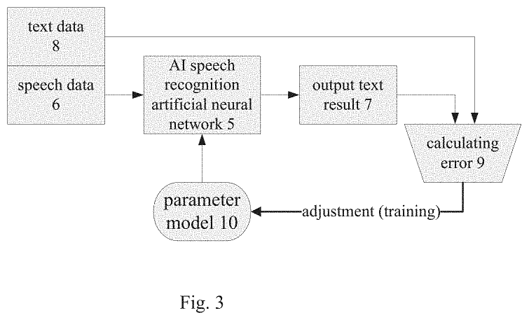

FIG. 3 further describes how to generate various speech models according to the present invention. Referring to FIG. 3, an artificial neural network 5 is used as a trainee for learning AI speech recognition. Various speech data 6 are inputted into the artificial neural network 5 for generating a text result 7. Thereafter the text result 7 and a text data 8 are inputted into the calculating error 9. The result of the calculating error 9 is inputted into a parameter model 10 for adjustment, and then to be inputted into the artificial neural network 5 for generating the text result 7 again. Repeat in this way for several times to obtain a best parameter model 10, this is so-called the learning and training stage.

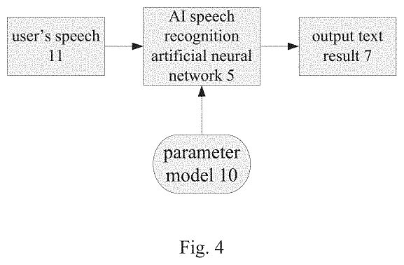

After a lot of learning and training, the text data 8 and the calculating error 9 are removed, as shown in FIG. 4, therefore a parameter model 10 of Automatic Speech Recognition (ASR) in relevant field is obtained, in which the user's speech 11 is inputted.

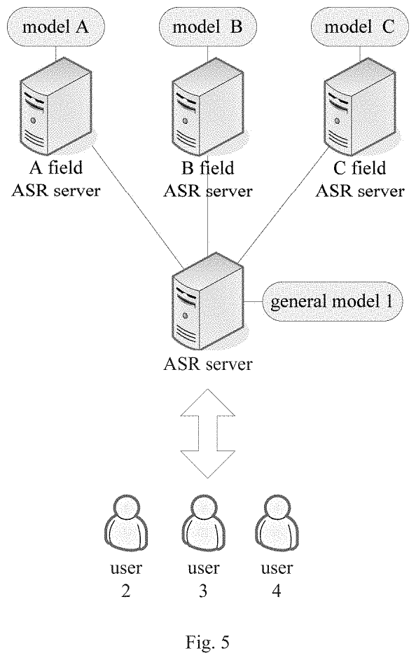

Referring to FIG. 5, after the processing in FIG. 3 and FIG. 4, different parameter models 10 are prepared respectively for users 2, 3, and 4 in different fields, i.e. model A, B, C, and are selected for using by users 2, 3, and 4 respectively. The original general model 1 is used by general people.

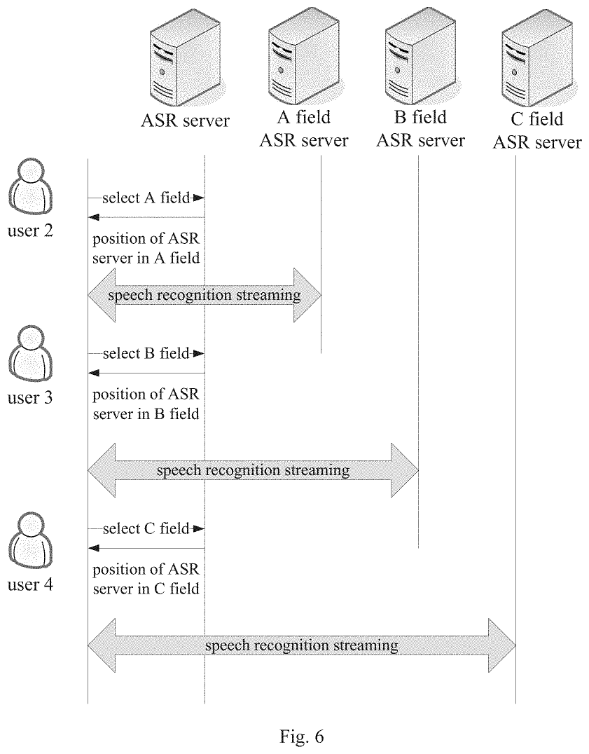

FIG. 6 describes that the users 2, 3, 4 make a selection to the ASR server of a general model 1 respectively. The user 2 requests the ASR server of a general model 1 to select the speech recognition service in A field, so the ASR server of the general model 1 provides the position of ASR server of the A field, and let the user 2 and the model A form a speech recognition streaming for service.

The user 3 requests the ASR server of a general model 1 to select the speech recognition service in B field, so the ASR server of the general model 1 provides the position of ASR server of the B field, and let the user 3 and the model B form a speech recognition streaming for service.

The user 4 requests the ASR server of a general model 1 to select the speech recognition service in C field, so the ASR server of the general model 1 provides the position of ASR server of the C field, and let the user 4 and the model C form a speech recognition streaming for service.

If a user has no special choice, the ASR speech recognition server of the general model 1 provides speech recognition services for the users.

The scope of the present invention depends upon the following claims, and is not limited by the above embodiments.

What is claimed is:

1. An AI speech recognition system capable of selecting models, comprising:
(a) an AI speech recognition server of a general model;
(b) prepare at least one different AI speech recognition server of a special model;
(c) the at least one different AI speech recognition server of the special model is controlled by the AI speech recognition server of the general model to accept a selection of different users for providing speech recognition service for the different users;
(d) if the different users have no special choice, then the AI speech recognition server of the general model provides speech recognition services for the different users.

2. The AI speech recognition system capable of selecting models according to claim 1, wherein the at least one different AI speech recognition server of the special model is generated by using an artificial neural network as a trainee for learning AI speech recognition; various speech data are inputted into the artificial neural network for generating a text result; thereafter the text result and a text data are inputted into a calculating error; a result of the calculating error is inputted into a parameter model for adjustment, and then to be inputted into the artificial neural network for generating the text result again; repeat in this way for several times to obtain a best parameter model; after a lot of learning and training, the text data and the calculating error are removed to obtain the special model of speech recognition server in relevant field.
